(19) United States
(12) Patent Application Publication
(10) Pub. No.: US 2017/0050108 A1
(43) Pub. Date: Feb. 23, 2017

(54) Method of Synchronising Human Activity That Includes Use of a Portable Computer Device With Audio Output From a Primary Device

(71) Applicant: MNET Mobile Pty Ltd.

(72) Inventors: Travis Johnson, New South Wales (AU); Luigi Iuliano, South Australia (AU)

(21) Appl. No.: 15/123,466

(22) PCT Filed: Apr. 22, 2014
(86) PCT No.: PCT/AU2014/050020

§ 371 Date: Sep. 2, 2016

(30) Foreign Application Priority Data
Mar. 6, 2014 (AU) 2014900764

(51) Int. Cl. A63F 13/215; A63F 13/216; A63F 13/812; A63F 13/35; A63F 13/46; A63F 13/92; A63F 13/211; A63F 13/335

(52) U.S. Cl. CPC A63F 13/215; A63F 13/211; A63F 13/216; A63F 13/335; A63F 13/35; A63F 13/46; A63F 13/92; A63F 13/812

(57) ABSTRACT

Non-transient computer-readable data storage having, stored thereon, computer executable instructions which, when executed by one or more processors of a portable computer device that includes a microphone and sensor devices, cause the computer device to perform a method of synchronising human activity that includes use of the computer device with audio output from a primary device, the method including the steps of receiving audio input from the primary device through the microphone; comparing said audio input with known audio data; if the audio input matches the known audio data, then waiting for a first period of time associated with the known audio data; and recording sensory data from the sensor devices for a second period of time associated with the known audio data, wherein the second period of time indicative of the period within which the user is expected to perform the human activity.

### TECHNICAL FIELD OF THE INVENTION

The present invention relates to a method of synchronising human activity that includes use of a portable computer with audio output from a primary device with device.

### BACKGROUND OF THE INVENTION

Television networks typically include systems for recording television programs and advertisements. The networks also include systems for broadcasting the television programs and the advertisements to a broadcast area. The signal carrying the television program and/or the advertisements is received by antennas connected to the rooves of houses in the broadcast area, for example. The signal is transmitted from the antennas to television sets connected thereto. The television sets display the visual components of the signal on a visual display unit and output the audio component of the signal through one or more speakers.

Television programs and advertisements, for example, have previously been generated to providing interesting content to a target audience. However, they may not have been able to provide a mechanism though which the audience can interact with the program or advertisement. That is, the audience may only be able to passively observe the audio visual content of a television program or advertisement.

In some instances, a television program, for example, might include a call to action, or request, whereby the viewers are asked, or encouraged, to respond in a specified manner. This may be as simple as following an exercise routine or as complicated as making a cake. The call to action may be an emotional plea to the audience such as showing a series of children starving in Africa and then asking the audience to donate money by ringing a certain telephone number. Alternatively, the advertisement might ask the audience to call a certain number with a view to purchasing a good or a service.

In the above-described examples, the television program or the advertisement is used to engage the audience and then ask them to perform some task that is separate from the audio visual being displayed on the television. There may be some degree of synchronisation between the advertisement and the call to action. However, the timing for the synchronised activity may not be critical to the outcome of the user's actions. That is, the required task can be performed in the viewer's own time. There may not be any direct interaction between the viewer and broadcast content.

It is generally desirable to overcome or ameliorate one or more of the above mentioned difficulties, or at least provide a useful alternative.

### SUMMARY OF THE INVENTION

In accordance with the invention there is provided non-transient computer-readable data storage having, stored thereon, computer executable instructions which, when executed by one or more processors of a portable computer device that includes a microphone and sensor devices, cause the computer device to perform a method of synchronising human activity that includes use of computer device with audio output from a primary device, the method including the steps of:
(a) receiving audio input from the primary device through the microphone;
(b) comparing said audio input with known audio data;
(c) if the audio input matches the known audio data, then:
   (i) waiting for a first period of time associated with the known audio data; and
   (ii) recording sensory data from the sensor devices for a second period of time associated with the known audio data,
wherein the second period of time indicative of the period within which the user is expected to perform the human activity.

Preferably, the first period of time and the second period of time are saved with the known audio data in an audio library on the device.

Preferably, the step of recording is initiated a predetermined amount of time before expiration of said first period of time. The predetermined amount of time is preferably one second.

Preferably, the step of recording is terminated a predetermined amount of time after expiration of said second period of time. The predetermined amount of time is preferably one second.

Preferably, the storage also includes instructions for performing the steps of:
(a) generating behaviour data from the sensory data, said behaviour data representing a model of the user's behaviour during the human activity;
(b) comparing the behaviour data with optimal data representing an optimal model of user behaviour during said human activity; and
(c) generating results data representing how closely the behaviour data approximates the optimal data.

In accordance with the invention, there is also provided a computer-readable storage medium having computer executable instructions stored thereon which, when executed by a computer, cause the computer to perform a method for synchronising an action or activity between a primary device and secondary device, wherein the sensor devices on secondary device create a model of the activity performed by the device user, and use that information to compare it to an expected action, then provide feedback to the user.

Preferably, there is content including an audio signal which is watermarked and transmitted by the primary device.

Preferably, the watermarking in the audio signal from the primary device is used by the secondary device to synchronise timing between the devices.

Preferably, content delivered from the primary device is of a nature to encourage the user to use the secondary device in a way similar to a game, and perform and action or activity, like swipe, swing, hit, etc.

Preferably, synchronisation between the primary and secondary devices is required in order for the secondary device to know when the recording of the user behaviour is to occur.

Preferably, accuracy of the synchronisation is critical as time is an element of the calculation used to compare the secondary device user's action with the model of the expected action, and perfect model of the action.

Preferably, the secondary device includes various technologies that enable the recording of the movement and behaviour of the device. These secondary device technologies include, but are not limited to, a gyroscope, GPS, accelerometer and compass.

Preferably, the results recorded as a result of the user's action with the secondary device are used to compare to the action expected as a result of the content provided by the primary device.

Preferably, the secondary device recorded information is combined and processed to create a model of the correct expected action, then compared to a model, or algorithm, of the correct expected action to assess how good or accurate the users action was, compared to the correct model.

Preferably, the secondary device user is then provided feedback through the devices feedback components, such as the screen, the microphone, alarms, etc, to indicate the user's accuracy against the perfect model of the desired action.

In accordance with the invention, there is also provided a system for synchronising human activity that includes use of a portable computer device with audio output from a primary device, said system comprising:

(a) a computer system;
(b) the above described computer readable data storage, in communication with the computer system.

### BRIEF DESCRIPTION OF THE DRAWINGS

Preferred embodiments of the present invention are hereafter described, by way of non-limiting example only, with reference to the accompanying drawing in which:

FIG. 1 is a schematic diagram of a system for synchronising an action or activity between a primary device and secondary device;

FIG. 2 is a flow diagram showing steps performed by component parts of the system shown in FIG. 1;

FIG. 3 is a schematic diagram of an application server for implementing part of the system shown in FIG. 1;

FIG. 4 is a schematic diagram of hand held computer device for use in the system shown in FIG. 1; and

FIG. 5 is a flow diagram showing steps performed by the device shown in FIG. 4; and

FIGS. 5a to 7d show interfaces generated by application software running on the hand held computer device shown in FIG. 1.

### DETAILED DESCRIPTION OF PREFERRED EMBODIMENTS OF THE INVENTION

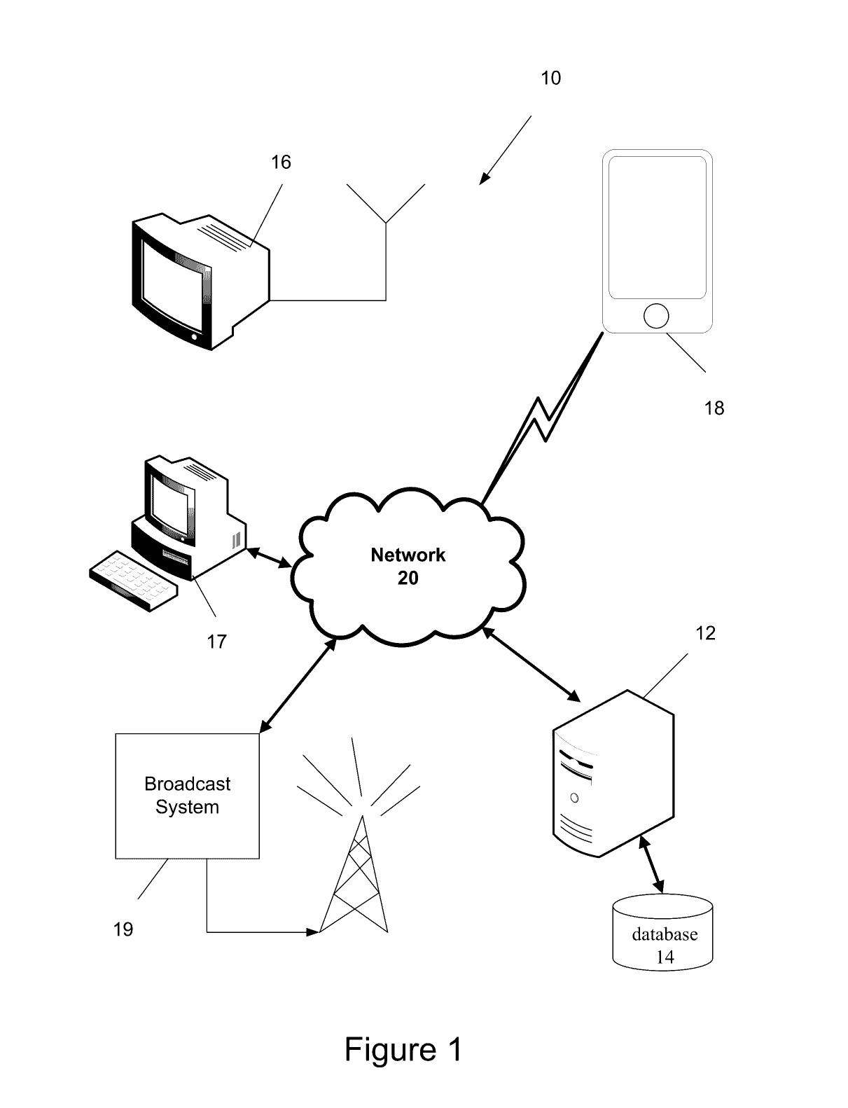

The system 10 shown in FIG. 1 is used for synchronising human activity that includes use of a portable computer device 18, such as a smart phone, with audio output from a primary device 16, such as a television or a radio. The system 10 also includes a broadcast system 19 that is adapted to generate and send broadcast segments to primary devices 16 in a broadcast area. For example, the broadcast system 19 is adapted to generate television advertisements and broadcast them to television sets in the broadcast area.

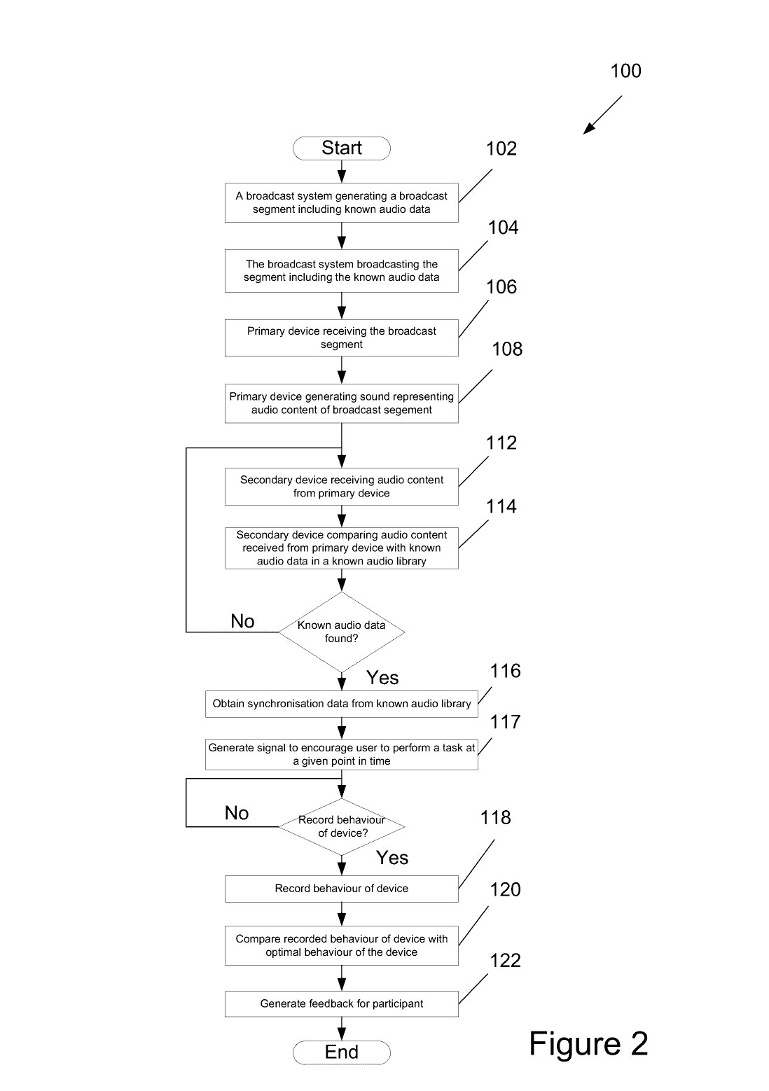

The system 10 is adapted to perform the steps 100 set out in FIG. 2. To this end, the broadcast system 19 is configured to:
1. generate, at step 102, a broadcast segment for receipt by primary devices 16 in the broadcast area, including known audio data; and
2. broadcast, at step 104, the broadcast segment and the known audio data to the primary devices in the broadcast network.

Each primary device 16 is configured to:

1. receive, at step 106, the broadcast segment from the broadcast system 19; and
2. generate sound, at step 108, representing audio content of the broadcast segment.

The known audio data is, for example, any known audio signal. For example, the known audio data is the sound of a bell chiming that is included in the audio generated by the primary device and is separately stored in a known audio library on the portable device 18. Alternatively, the known audio data is known watermark data that is included in the audio generated by the primary device and is separately stored in a known watermark library on the portable device 18. Alternatively, the known audio data is any other suitable audio indicia, that can be detected and matched against known audio data in a known audio library on the device 18. For ease of description, preferred embodiments of the invention are hereafter described, by way of non-limiting example, with reference to the known audio data being known watermark data that is stored in a known watermark library on the device 18.

Each device 18 includes an application program (Game App) 224 stored thereon that, when executed by one or more processors of the device 18 causes the device 18 to:

1. receive, at step 112, the audio content of the from the primary device 16;
2. compare, at step 114, the audio content with a watermark library to identify a valid watermark (also referred to as a known watermark);
3. when a valid watermark is identified in the audio content, the application 244 obtains, at step 116, the synchronisation data from the watermark library, or other area of data storage on the device 18, and starts synchronising time with the broadcast signal and then generates, at step 117, a signal to the user to encourage the user to perform a task at a given point in time;
4. at the given point in time, record, at step 118, behaviour of the device 18;
5. compare, at step 120, recorded behaviour with optimal behaviour; and
6. generate feedback, at step 122, for participant indicating how closely his or her action compared with the optimal action.

The step of generating a signal to the user to encourage the user to perform a certain task a given point in time is preferably generated by the Game App 224. Alternatively, the signal is generated by the broadcast segment through the primary device 16.

Preferred embodiments of the system 10 are described below, by way of non-limiting example, with reference to the broadcast segments being television advertisements prompting viewers to interact with advertisements using their smart phones 18. However, the broadcast segments could, alternatively, be a radio advertisements, or any other broadcast segments that include audio content.

### Application Server 12

The system 10 also includes an application server 12 and an associated database 14. The application server 12 is adapted to communicate with the handheld computer devices 18 and other computer devices 17 over a communications network 20 using standard communication protocols.

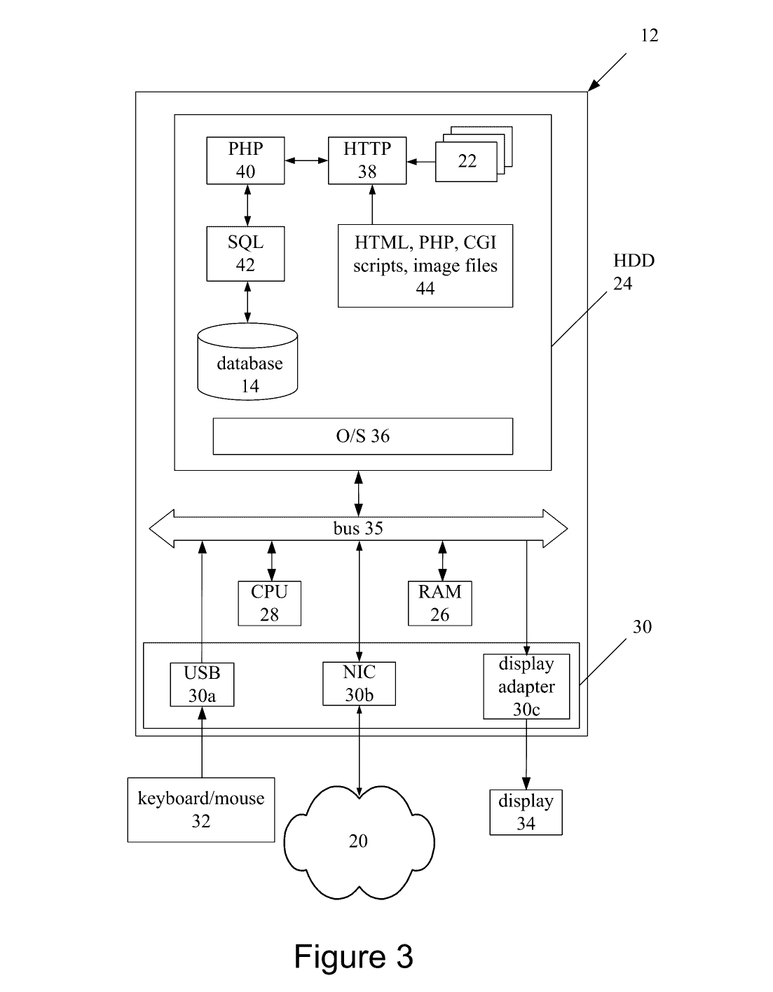

The application server 12 is used to collect user registration details and to provide some configuration and model calibration data and information to the mobile application 224 running on the portable computer device 18. The server 12 is in communication with a database 14, as shown in FIG. 3. The server 12 is able to communicate with equipment 17 of members, or users, over a communications network 20 using standard communication protocols. The equipment 17 of the members can be a variety of communications devices such as personal computers; laptop computers, notepads, smart phones; hand held computers etc. The communications network 20 may include the Internet, telecommunications networks and/or local area networks.

The components of the server 12 can be configured in a variety of ways. The components can be implemented entirely by software to be executed on standard computer server hardware, which may comprise one hardware unit or different computer hardware units distributed over various locations, some of which may require the communications network 20 for communication. A number of the components or parts thereof may also be implemented by application specific integrated circuits (ASICs) or field programmable gate arrays.

In the example shown in FIG. 3, the server 12 is a commercially available server computer system based on a 32 bit or a 64 bit Intel architecture, and the processes and/or methods executed or performed by the server 12 are implemented in the form of programming instructions of one or more software components or modules 22 stored on non-volatile (e.g., hard disk) computer-readable storage 24 associated with the computer system 12. At least parts of the software modules 22 could alternatively be implemented as one or more dedicated hardware components, such as application-specific integrated circuits (ASICs) and/or field programmable gate arrays (FPGAs).

The server 12 includes at least one or more of the following standard, commercially available, computer components, all interconnected by a bus 35:

1. random access memory (RAM) 26;
2. at least one computer processor 28, and
3. external computer interfaces 30:
a. universal serial bus (USB) interfaces 30a (at least one of which is connected to one or more user-interface devices, such as a keyboard, a pointing device (e.g., a mouse 32 or touchpad),
b. a network interface connector (NIC) 30b which connects the computer system 12 to a data communications network, such as the Internet 20; and
c. a display adapter 30c, which is connected to a display device 34 such as a liquid-crystal display (LCD) panel device.

The server 12 includes a plurality of standard software modules, including:
1. an operating system (OS) 36 (e.g., Linux or Microsoft Windows);
2. web server software 38 (e.g., Apache, available at http://www.apache.org);
3. scripting language modules 40 (e.g., personal home page or PHP, available at http://www.php.net, or Microsoft ASP, or JAVA); and
4. structured query language (SQL) modules 42 (e.g., MySQL, available from http://www.mysql.com), which allow data to be stored in and retrieved/accessed from an SQL database 16.

Together, the web server 38, scripting language 40, and SQL modules 42 provide the server 12 with the general ability to allow users of the Internet 20 with standard computing devices 18 equipped with standard web browser software to access the server 12 and in particular to provide data to and receive data from the database 14. It will be understood by those skilled in the art that the specific functionality provided by the server 12 to such users is provided by scripts accessible by the web server 38, including the one or more software modules 22 implementing the processes performed by the server 12, and also any other scripts and supporting data 44, including markup language (e.g., HTML, XML) scripts, PHP (or ASP, or JAVA), and/or CGI scripts, image files, style sheets, and the like.

The boundaries between the modules and components in the software modules 22 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes of the server 12 may be executed by a module (of software modules 22) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The server 12 normally processes information according to a program (a list of internally stored instructions such as a particular application program and/or an operating system) and produces resultant output information via input/output (I/O) devices 30. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

### Use of the Application Server 12

A user can use his of her computer 17, or mobile 18, to access the login page (not shown) generated by the server 12. If the user has an existing account, then the server 12 generates a profile page (not shown) for the user on receipt of a correct user name and password.

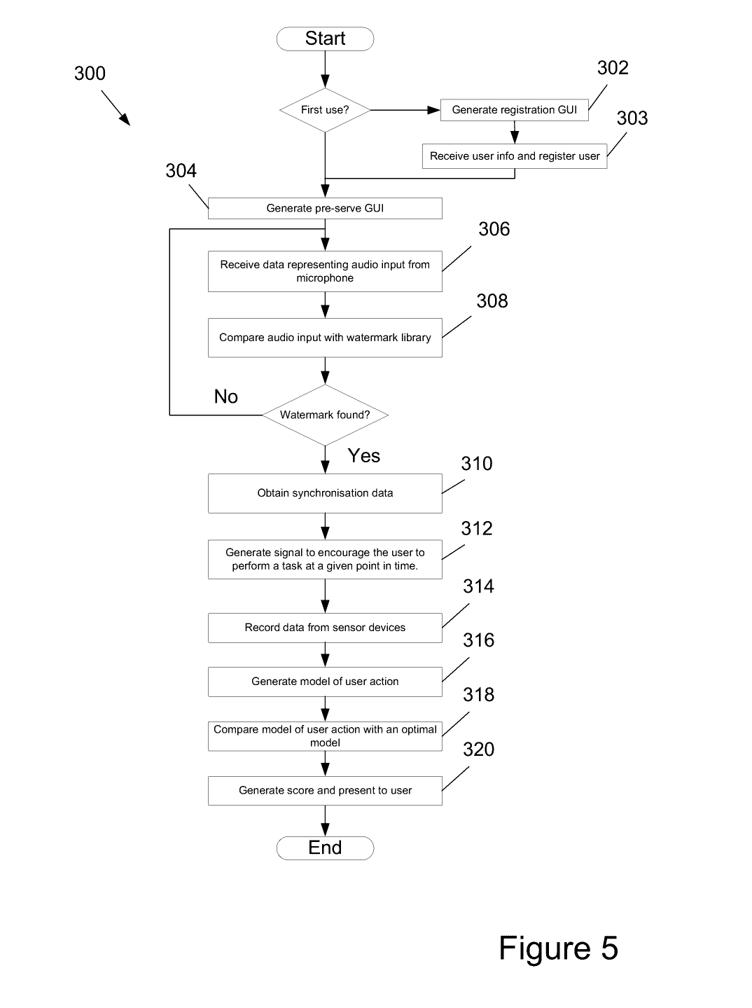

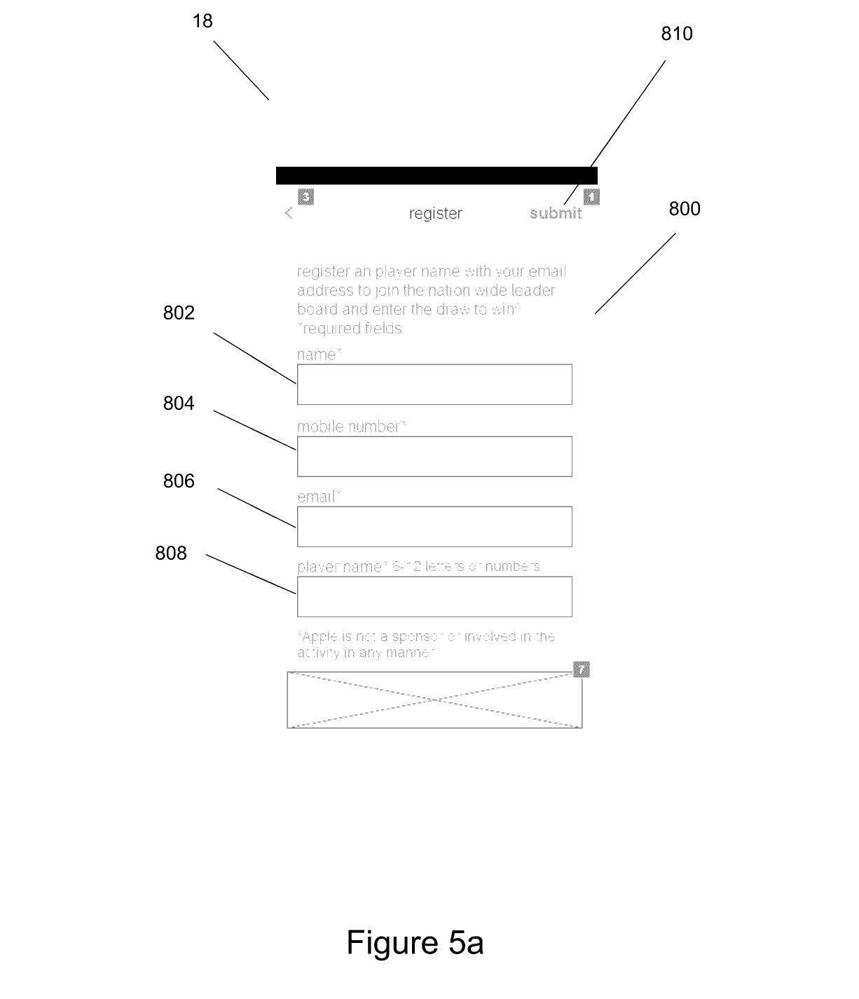

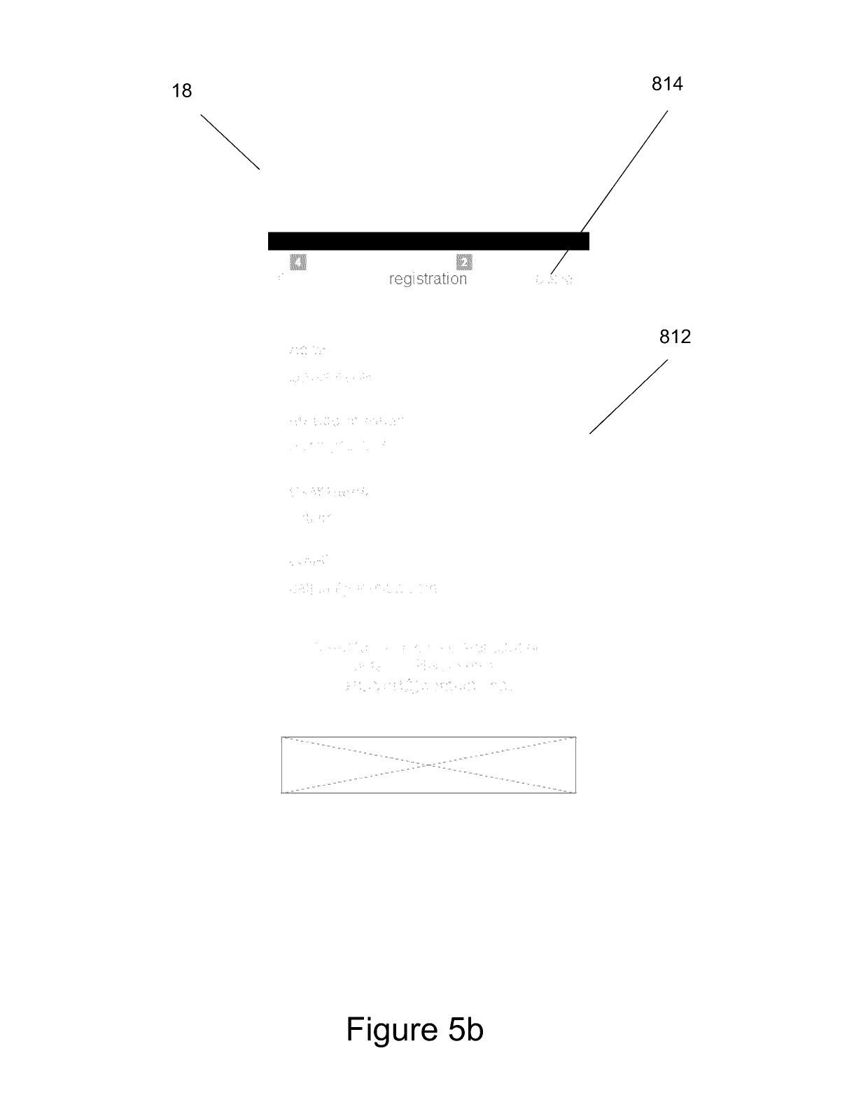

For a first time user, the user can select the “Create Account” function button. On execution of this function button, the server 12 generates the new user page 800 shown in FIG. 5a with the following data boxes:

### 1. Name 802;

2. Mobile telephone number 804
3. E-mail address 806;
4. Player name 808.

Once this information has been entered by the user using his or her computer device 17, the user executes the “Submit” function button 810 and the system generates an account for the user and also generates a profile page (Not shown) for display on the user's device 17.

From the profile page, the user can configure and model calibration data of the Game Application 224 stored on the handheld computer device 18. These processes are described in further detail below.

The application server 12 is adapted to receive information, such as game scores, from the mobile devices 18 of the users of the system 10 and store them in the database 14. The collection of scores is kept on the server 12 for later access from the user profiles.

### Broadcast System 19

The broadcast system 19 is adapted to:
1. generate a broadcast segment for a television program or a television advertisement, including audio visual content for display on a television 16 or other visual display unit;
2. generate watermark data for a secondary device 18;
3. encode the broadcast segment with the know watermark data; and
2. broadcast the segment and the know watermark data to the primary devices 16 in a broadcast network.

The above-described processes for creating, generating and broadcasting an advertisement, excluding known watermark data, are known in the art and are not described here in further detail.

Alternatively, the broadcast system 19 is adapted to perform the above steps for a broadcast segment of a radio program or a radio advertisement. In this embodiment, the broadcast segment is received and played by radio devices 16.

The watermarking in the audio signal is generated as sound by the primary device 16 and is used by the secondary device 18 to synchronise timing between the devices. The content delivered in the broadcast segment from the primary device 16 is of a nature to encourage the user to use the secondary device 18 in a way similar to a game, and perform and action or activity, like swipe, swing, hit, etc. The synchronisation between the primary 16 and secondary 18 devices is required in order for the secondary device 18 to know when the recording of the user behaviour is to occur. The accuracy of the synchronisation is critical as time is an element of the calculation used to compare the secondary device 18 user's action with the expected action, and an optimal model of the action.

### The Portable Computer Device 18

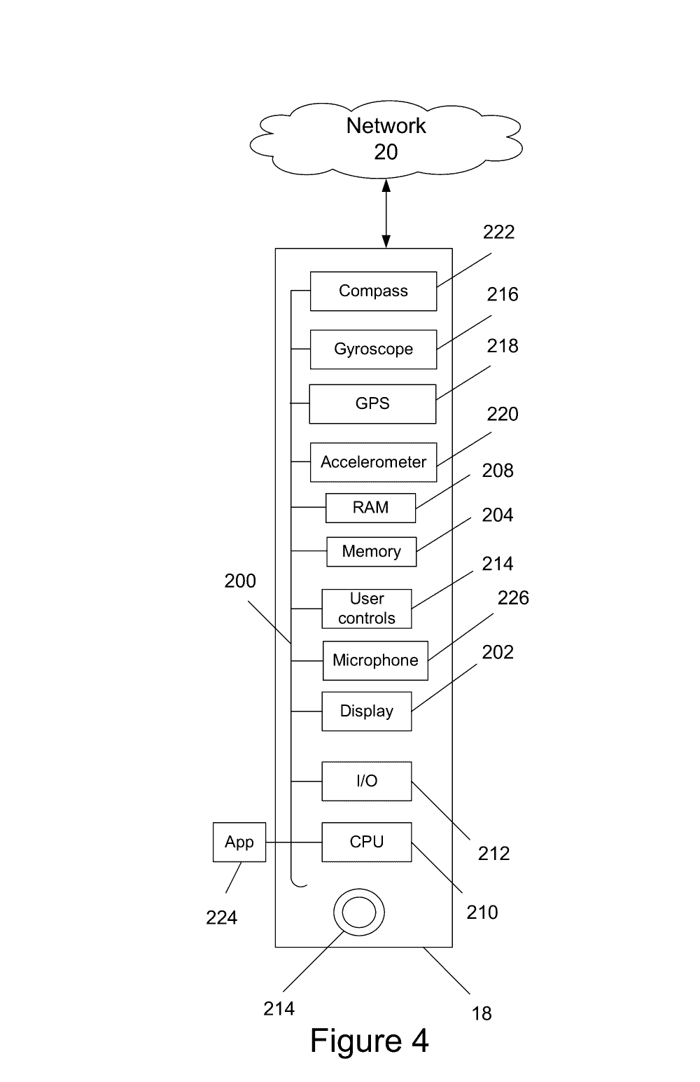

The portable computer device 18 (HCD) is preferably a mobile device 18 such as a smart phone or a PDA such as one manufactured by Apple™, LG™, HTC™, Research In Motion, and Motorola. For example, the HCD 18 is a mobile computer such as a tablet computer. An exemplary embodiment of the HCD 18 is shown in FIG. 4. As shown, the device 18 includes the following components in electronic communication via a bus 200:

1. a display 202;
2. non-volatile memory 204;
3. random access memory (“RAM”) 208;
4. N processing components 210;
5. a transceiver component 212 that includes N transceivers; and
6. user controls 214.

As also shown in FIG. 4, the secondary device 18 includes various technologies that enable the recording of the movement and behaviour of the device 18. These secondary device technologies include, but are not limited to, one or more of the following motion sensor devices:

1. a gyroscope 216;
2. a global positioning system receiver 218;
3. an accelerometer 220; and
4. a compass 222.

The sensor devices may also include a heart rate monitor (not shown) and a heat detector (not shown).

Although the components depicted in FIG. 4 represent physical components, FIG. 4 is not intended to be a hardware diagram; thus many of the components depicted in FIG. 4 may be realized by common constructs or distributed among additional physical components. Moreover, it is certainly contemplated that other existing and yet-to-be developed physical components and architectures may be utilized to implement the functional components described with reference to FIG. 4.

The display 202 generally operates to provide a presentation of content to a user, and may be realized by any of a variety of displays (e.g., CRT, LCD, HDMI, micro-projector and OLED displays). And in general, the non-volatile memory 204 functions to store (e.g., persistently store) data and executable code including code that is associated with the functional components of an App 224 (also referred to as Game App 224). In some embodiments for example, the non-volatile memory 204 includes bootloader code, modem software, operating system code, file system code, and code to facilitate the implementation of one or more portions of the Game App 224 as well as other components well known to those of ordinary skill in the art that are not depicted nor described for simplicity.

In many implementations, the non-volatile memory 204 is realized by flash memory (e.g., NAND or ONENAND memory), but it is certainly contemplated that other memory types may be utilized as well. Although it may be possible to execute the code from the non-volatile memory 204, the executable code in the non-volatile memory 204 is typically loaded into RAM 208 and executed by one or more of the N processing components 210.

The N processing components 210 in connection with RAM 208 generally operate to execute the instructions stored in non-volatile memory 204 to effectuate the functional components depicted in FIG. 4. As one of ordinarily skill in the art will appreciate, the N processing components 210 may include a video processor, modem processor, DSP, graphics processing unit (GPU), and other processing components.

The transceiver component 212 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

It should be recognized that FIG. 4 is merely exemplary and in one or more exemplary embodiments, the functions described herein may be implemented in hardware, software, firmware, or any combination thereof. If implemented in software, the functions may be stored on or transmitted over as one or more instructions or code encoded on a non-transitory computer-readable medium. Non-transitory computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fibre optic cable, twisted pair, digital subscriber line (DSL), or wireless technologies such as infrared, radio, and microwave, then the coaxial cable, fibre optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The portable device 18 is preferably adapted to be worn by the user. For example, the portable device is embodied as a wrist watch or forms part of the clothing worn by the user.

### Game App 224

The Game App 224 is downloaded and installed on to the device 18 from the iTunes™ or Google Play™ stores, for example, using standard processes.

When the user selects the Game App 224 from the display 202 of the mobile device 18, the Game App 224 performs the steps 300 set out in FIG. 5.

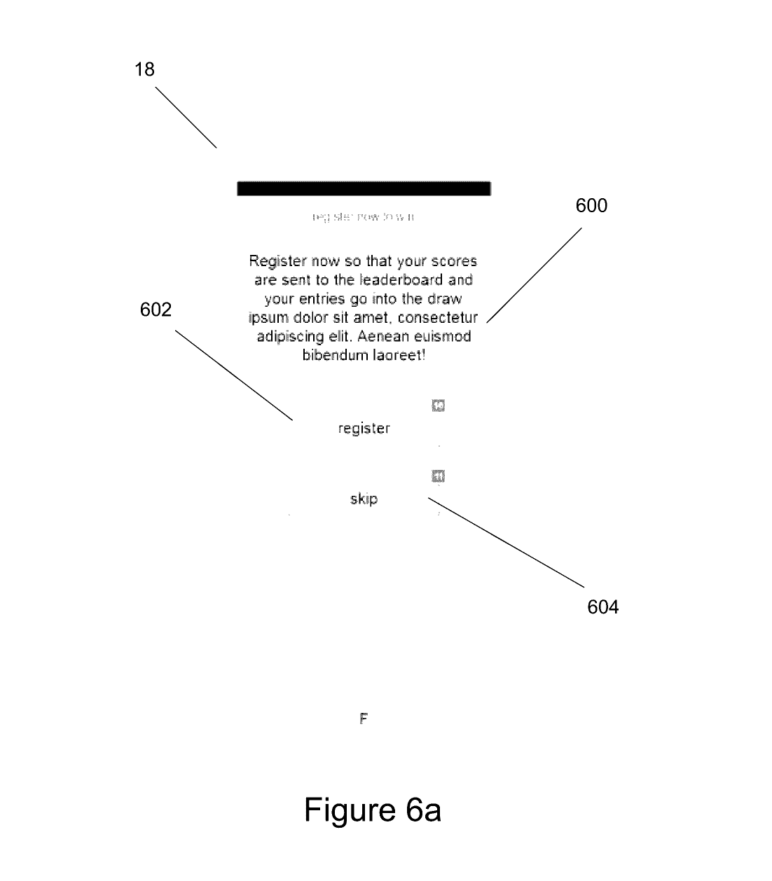

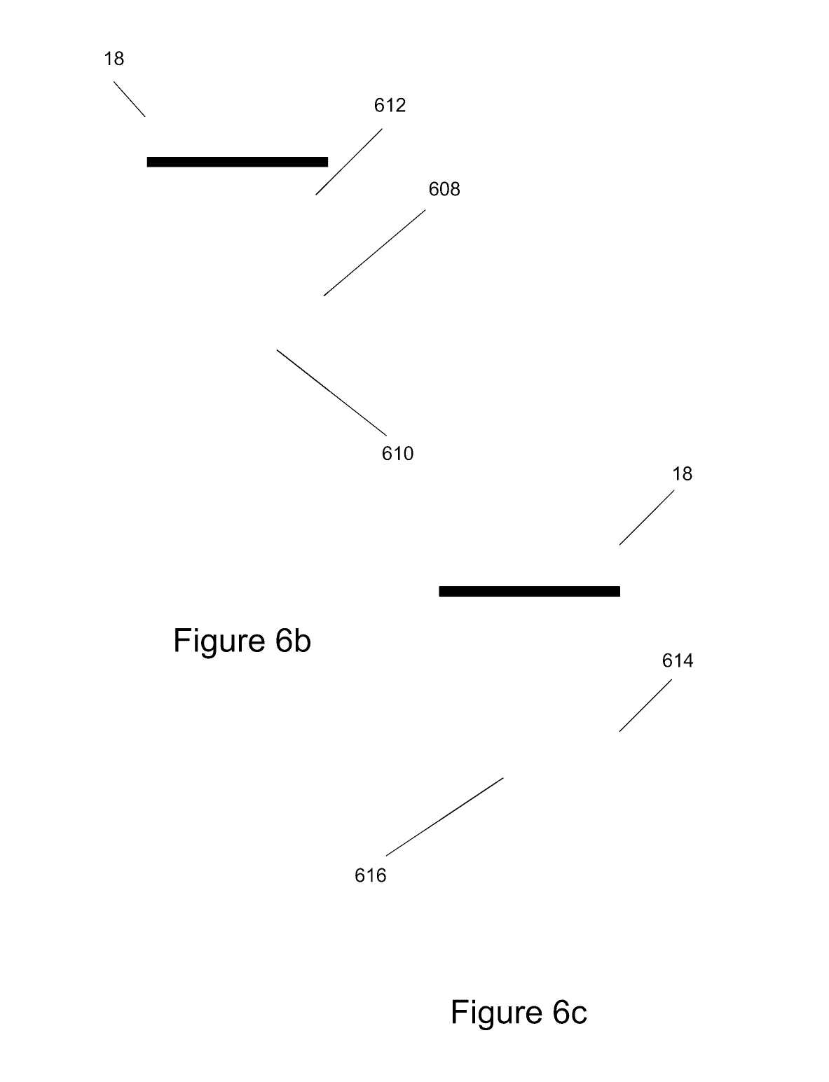

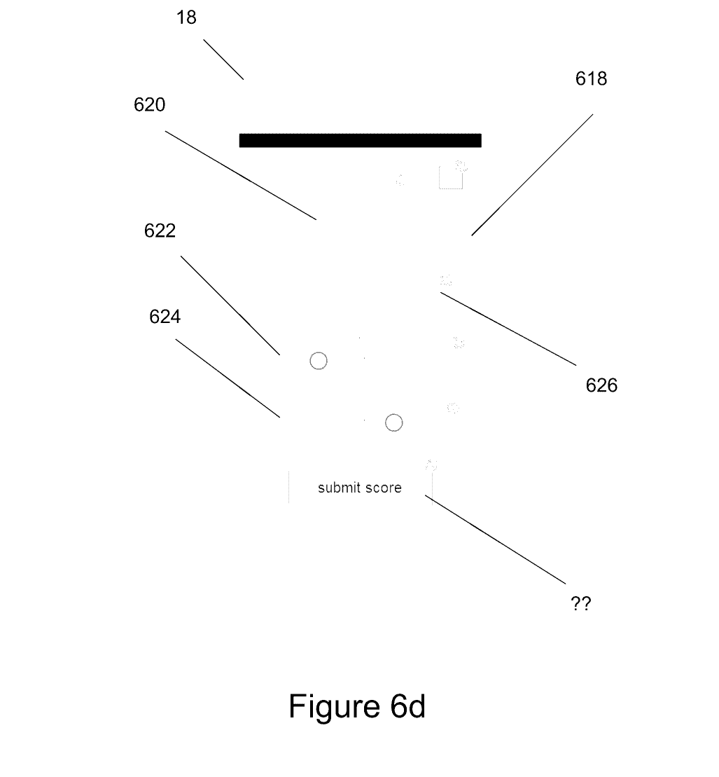

When the Game App 224 is loaded for the first time, it generates, at step 302, the registration graphical user interface (GUI) 600 shown in FIG. 6. The registration GUI 600 includes a “Register” function button 602 that, when executed by the user, generates the register GUI 800 shown in FIG. 5a that include the following data boxes:

### 1. Name 802;

2. Mobile telephone number 804
3. E-mail address 806;
4. Player name 808.

The Game App 224 receives, at step 303, this information and when the user executes the “Submit” function button 810 and the system 10 generates an account for the user and also generates the confirmation GUI 812 shown in FIG. 5b. If the details are correct, the user selects the “done” function button 814 and the Game App 224 generates, at step 304, the pre-serve GUI 608 shown in FIG. 6b and displays it on the device 18.

Otherwise, the user can select the “Skip” function button 604 to go directly into the game generates, at step 304, the pre-serve GUI 608 shown in FIG. 6b and displays it on the device 18 for the user.

The pre-serve GUI 608 include a indicia 610 indicating to the user that he or she is to wait for service of the tennis ball. The pre-serve GUI 608 also includes other indicia 612 that provides some basic instructions to the user about how to play the game.

The Game App 224 receives, at step 306, data representing audio content from the primary device 16 via the microphone 226 and compares, at step 308, the audio content with known audio data (for example, known watermark data) stored in a known audio library (for example, a known watermark library) on the device 18. The mobile application 224 takes control of the mobile device microphone 226 in order to collect the audio signal and search for known audio data in the audio. Preferred embodiments are below described, by way of non limiting example, with reference to the known audio data being known watermark data.

When the audio input received from the audio device 16 is matched with a watermark in the watermark library, the Game App 224 sets a timer to synchronise the time in the primary and secondary devices, at step 310. In other words, once a watermark is found, the Game App 224 continues to monitor the watermark to determine at what timeslot, or point in time, the audio is at. This creates a time synchronisation between the mobile application 224 and the audio signal collected from the microphone 226 of the mobile device 18.

The watermark library is used to recognise watermarks in an audio signal. Using the watermarking library, the mobile application 224 is able to know at what timeslot or point in the audio file the audio file has reached. The mobile application 224 is then synchronised to the continuous playing of the audio file.

On detection of the watermark, the Game App 224 generates, at step 312, a signal to encourage the user of the mobile application 224 to perform some action at a given point in time. For example, the Game App 224 generates the get set GUI 614 shown in FIG. 6c which includes indicia 616 that informs the user that the tennis ball has been served and is coming towards them. Preferably, the timing of the incoming tennis ball is synchronised with television 16 footage of the ball being served. Alternatively, the signal to encourage the user to perform the action is generated by the primary device 16 only.

The optimal point in time at which the action should be performed is at some time in the future, determined by the time synchronisation between the mobile application 224 and the primary device 16.

When the specific point in time is reached for the action to be performed, the mobile application 224 collects, at step 314, data from one or more of the following motion sensor devices:

1. the accelerometer 220;
2. the gyroscope 216;
3. the compass 222; and
4. the GPS receiver 218.

The collected data is processed by the mobile application 224, and then a model of the user's action is created, at step 316, with this collected data. In the case of a tennis swing, the algorithm used to create this swing model. This process is described in further detail below.

Each of the collected statistics is then associated to a score based on how close to the perfect value each of the collected statistics is. Each collected value is then compared, at step 318, to the optimal value, and a score from 0 to 100 is assigned to that characteristic. This is repeated for each collected characteristic. Once each characteristic score is calculated, then they are combined and added up, at step 310, in order to determine the total score, from a maximum possible score. The maximum possible score is the total number of characteristics being measured, multiplied by 100.

The mobile application 224 then generates the results GUI 618 shown in FIG. 6d and displays in on the device 18 for the user. The results GUI 618 includes:
1. a score 620, representing the accuracy and effectiveness of their action, against an unknown optimal action model;
2. indicia 622 representing power of the action;
3. indicia 624 representing timing of the action; and
4. indicia 626 representing the type of return and the placement on the court,

The optimal action model is based on the correct amount of mobile device acceleration, and position in space, at a given point in time.

The above described example has been given with reference to a television 16. However, the television could alternatively be a Radio, DVR, an outdoor screen, gaming console, and or any other suitable device that is at least capable of transmitting a signal which contains an audio file.

The broadcast signal will encourage the use to perform some action with their mobile device 18, at a specific point in time. The television 16 transmits a signal that has as a component, an audio signal. The audio signal is watermarked for a period. The Game App 224 detects the audio signal and records the movement of the device 18.

The application server 12 is used to manage the configuration of the mobile application 224. The application server 12 has information that is sent to the mobile application 224 about the perfect and expected timing, and expected values required in order to achieve the perfect action score. When the mobile application 224 is first connected to the internet, it will request from the application server 12 the configuration values required in order to calculate the optimal action model.

The application server 12 sends to the mobile application 224, over the internet the specific values it would expect to receive from the mobile device if the value of each characteristic score was to be perfect. These values are then used to compare against the values collected by the mobile application 224 on the mobile device to get a score.

The application server 12 also receives the results of the mobile users action, and scores when they have completed their action. The score received by the application server 12 is then stored and associated with the registered user of the mobile application 224. The collection of scores is kept on the server for later use by the mobile application 224.

At any time the mobile application 224 can request all the scores achieved by the mobile application 224 user, and display them in the mobile application 224.

### Calculation Algorithm

There are a few pre-set variables in the application used to create a level of action difficulty, for which the values are read from the mobile device around the time the application synchronises with the trigger code (also referred to as the audio watermark). These include:
a. the perfectTime—the exact time that all the measured values taken from the mobile device should be perfect, and match all the other perfect values in order to achieve the perfect score, ie match the perfect model of the action
b. the threshold—the period during which measured values will be used for the model and
c. perfectPower—the perfect acceleration value expected for the perfect action.

The following variables are set:

a. startTime (as soon as the second trigger code was heard); and
b. endTime (a number of seconds after the perfectTime).

The threshold is a period of time less than the startTime and endTime, and the threshold must include the perfectTime. During the threshold period, all measurements taken are used for the model. By reducing the threshold, the mobile application 224 user must be more precise with their action, and the timing. If the action is not occurring during the threshold period, the user results will be poor.

When the audio trigger is heard we start recording the devices movements utilising the accelerometer's ability to track the x, y and z acceleration. For the purpose of swinging motion, only the y axis is tracked. We also tracked the exact time when the device updated any accelerometer value of the y-axis.

If the device had any acceleration along the y-axis during the threshold range, then the time difference from when the user achieved perfectPower are taken, to when they should have achieved it, at the perfectTime, and this time difference is used to calculate a score for power of the swing.

If the perfectPower is not achieved during the threshold period, then the difference in the recorded impactPower at the perfectTime, and the perfectPower is used to calculate a score for power.

The system then checks that when the endTime was reached, stop recording from the devices accelerometer and calculate the users overall score.

During the time of recording the devices movements we were also recording the fastest acceleration achieved by the device. This was used to then determine the peakPowerTime which is used in the calculation of the timing score. The timing score was worked out by the following:

float deltaTime=powerPeakTime−perfectTime

float timePercent=fabs(deltaTime)/1240;

float timingScore=(MAX_SCORE−(timePercent*MAX_SCORE))

To calculate the power score, we did the following.
float deltaPower=0
float powerPercentageMissed=0

```
if (impactPower > 0 && impactPower < maximumPower) {
      deltaPower = abs(perfectPower − impactPower)
      powerPercentageMissed = deltaPower / perfectPower
      float powerScore = (MAX_SCORE −
      (powerPercentageMissed * MAX_SCORE))
} else {
      powerScore = 0
}
```

The finalScore was just calculated by adding timingScore and powerScore together.

### Results

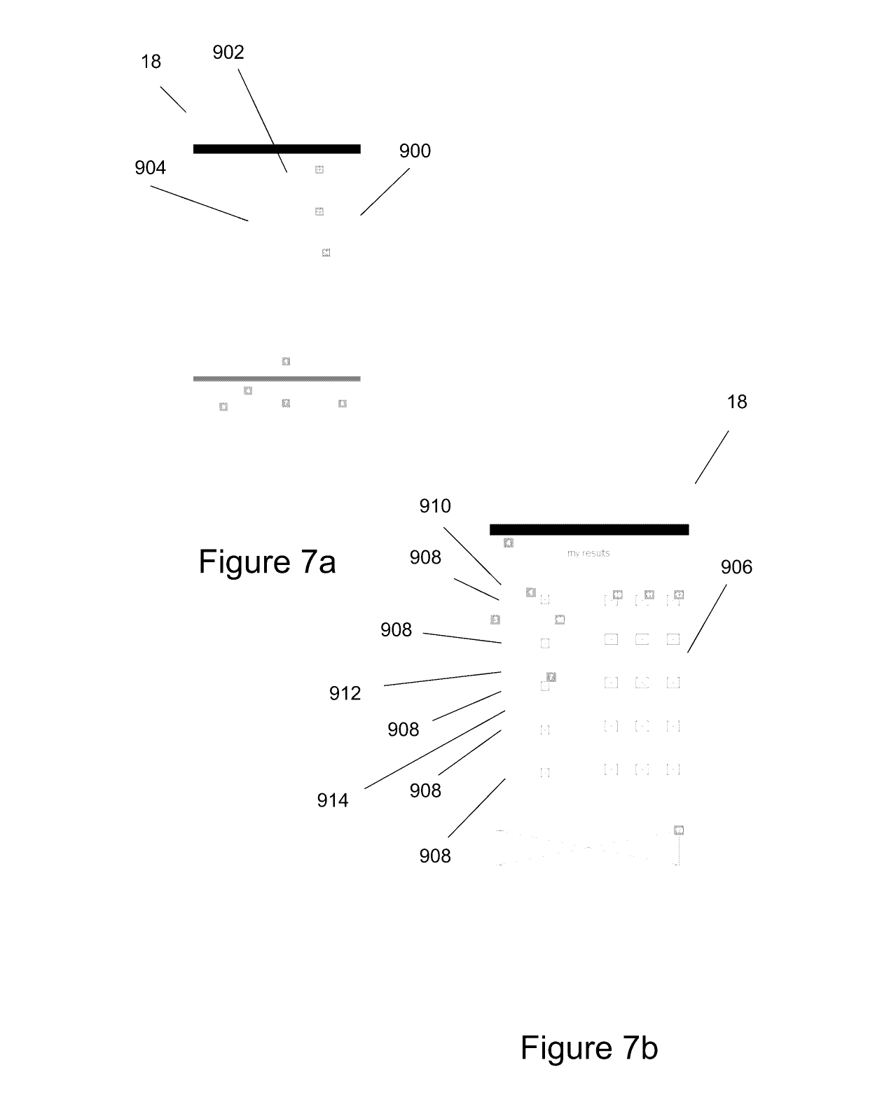

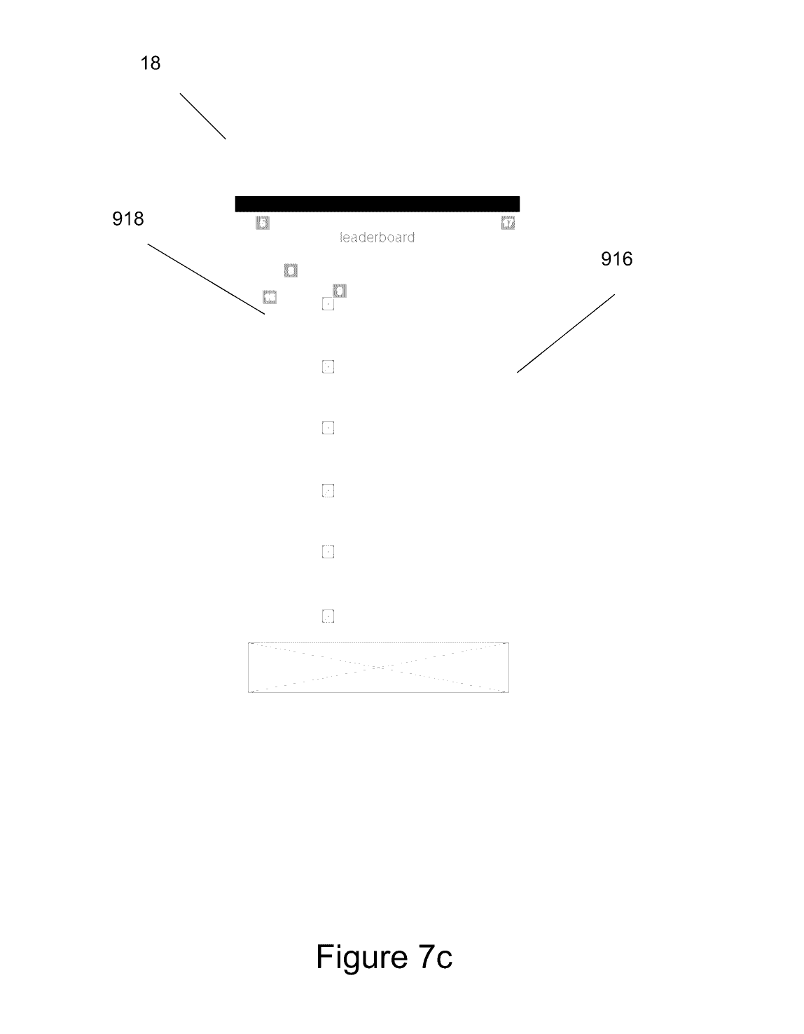

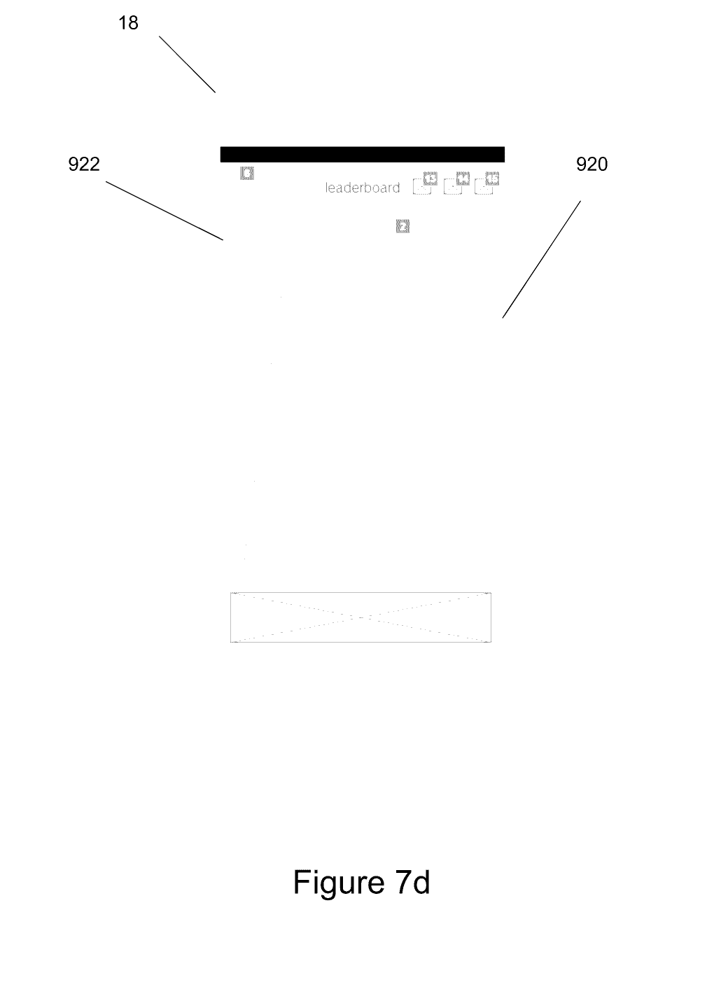

The user can access his or her device 18 to access the results GUI 900 shown in FIG. 7a which includes the following function buttons:

1. “my results” 902; and
2. “leader board” 904.

When the my results function button 902 is selected, the Game App 224 generates the My Results GUI 906 shown in FIG. 7b which includes the results 908 in the following categories:

a. easy 910;
b. medium 912; and
c. hard 914.

When the “leaderboard” function button 904 is selected, the Game App 224 generates the Leaderboard GUI 916 shown in FIG. 7c which includes the results 918 of the top 5 competitors. The leaderboard GUI 916 includes a “Find Me” function button (not shown) that when executed generates the GUI 920 shown in FIG. 7d which includes the relative position of the user on the scoreboard 922.

Many modifications will be apparent to those skilled in the art without departing from the scope of the present invention

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

1. Non-transient computer-readable data storage having, stored thereon, computer executable-instructions which, when executed by one or more processors of a portable computer device that includes a microphone and sensor devices, cause the computer device to perform a method of synchronising human activity that includes use of the computer device with audio output from a primary device, the method including the steps of:
(a) receiving audio input from the primary device through the microphone;
(b) comparing said audio input with known audio data;
(c) if the audio input matches the known audio data, then:
(i) waiting for a first period of time associated with the known audio data; and
(ii) recording sensory data from the sensor devices for second period of time associated with the known audio data, wherein the second period of time indicative of the period within which the user is expected to perform the human activity.

2. The storage claimed in claim 1, wherein the first period of time and the second period of time are saved with the known audio data in a known audio library on the device.

3. The storage claimed in claim 1, wherein the step of recording is initiated a predetermined amount of time before expiration of said first period of time.

4. The storage claimed in claim 3 wherein the predetermined amount of time is one second.

5. The storage claimed in claim 1, wherein the step of recording is terminated a predetermined amount of time after expiration of said second period of time.

6. The storage claimed in claim 5, wherein the predetermined amount of time is one second.

7. The storage claimed in claim 1, including the step of generating a signal to encourage the user to initiate the human activity at a given point in time.

8. The storage claimed in claim 7, including the step of displaying the signal on a visual display of the computer device.

9. The storage claimed in claim 7, including the step of sounding an audible noise representing said signal through speakers on said computer device.

10. The storage claimed in claim 1, including the steps of:
(a) generating behaviour data from the sensory data, said behaviour data representing a model of the user's behaviour during the human activity,
(b) comparing the behaviour data with optimal data representing an optimal model of user behaviour during said human activity; and
(c) generating results data representing how closely the behaviour data approximates the optimal data.

11. The storage claimed in claim 10, including the step of displaying the results data on a visual display of the device.

12. The storage claimed in claim 11, wherein the primary device is a television.

13. The storage claimed in claim 12, wherein sensor devices include one or more of:
(a) a gyroscope;
(b) a Global Positioning System receiver;
(c) an accelerometer; and
(d) a compass.

14. The storage claimed in claim 1, wherein the human activity includes using the computer device as a tennis racket to return a ball observed to be served in his or her direction on a television.

15. The storage claimed in claim 14, wherein the results data represents how closely the user's return of the tennis ball approximated that of an optimal return of the tennis ball.

16. The storage claimed in claim 14, wherein the results data also includes an indication of where the tennis ball was returned on court.

17. The storage claimed in claim 11, wherein the human activity includes using the computer device as a cricket bat to hit a cricket ball observed to be bowled in his or her direction on a television.

18. The storage claimed in claim 17, wherein the results data represents how closely the user's strike of the cricket ball approximated that of an optimal strike of the cricket ball.

19. The storage claimed in claim 17, wherein the results data also includes an indication of where the cricket ball was hit on field.

20. The storage claimed in claim 11, wherein the human activity include using the computer device as a baseball bat to hit a baseball observed to be pitched in his or her direction on a television.

21. The storage, claimed in claim 20, wherein the results data represents how closely the user's strike of the baseball approximated that of an optimal strike of the baseball.

22. The storage claimed in claim 20, wherein the results data also includes an indication of where the baseball was hit on field.

23. The storage claimed in claim 1, wherein the portable computer device is a hand held computer device.

24. The storage claimed in claim 23, wherein the hand held computer device is a smart phone.

25. The storage claimed in claim 1, wherein the portable computer device is a wearable computer device.

26. The storage claimed, in claim 1, wherein said known audio data is data representing a known audio signal.

27. The storage claimed in claim 26, wherein said known audio data is an audio watermark in the audio broadcast by the primary device.

28. A computer-readable storage medium having computer executable instructions stored thereon which, when executed by one or more processors of a portable computer device, cause the computer to perform a method for synchronising an action or activity between a primary device and secondary device, wherein the sensor devices on secondary device create a model of the activity performed by the device user, and use that information to compare it to an expected action, then provide feedback to the user.

29. The storage medium of claim 28, wherein there is content including an audio signal which is watermarked and transmitted by the primary device.

30. The storage medium of claim 29, wherein the watermarking in the audio signal from the primary device is used by the secondary device to synchronise timing between the devices.

31. The storage medium of claim 28, wherein content, delivered from the primary device is of a nature to encourage the user to use the secondary device in a way similar to a game, and perform an action or activity, like swipe, swing, hit, etc.

32. The storage medium of claim 28 any one of claims 28 to 31, wherein synchronisation between the primary and secondary devices is required in order for the secondary device to know when the recording of the user behaviour is to occur.

33. The storage medium of claim 32, wherein accuracy of the synchronisation is critical as time is an element of the calculation used to compare the secondary device user's action with the expected action, and perfect model of the action.

34. The storage medium of claim 28, wherein the secondary device includes one or more of a gyroscope, GPS receiver, accelerometer and a compass.

35. The storage medium of claim 28, wherein the results recorded as a result of the user's action with the secondary device are used to compare the model of the action expected as a result of the content provided by the primary device.

36. The storage medium of claim 28, wherein the secondary device recorded information is combined and processed to create a model of the correct expected action, then compared to a model, or algorithm, of the correct expected action to assess how good or accurate the users action was, compared to the correct model.

37. The storage medium of claim 28, wherein the secondary device user is then provided feedback through the devices feedback components, such as the screen, the microphone, alarms, etc., to indicate the user's accuracy against the perfect model of the desired action.

38. A system for of synchronising audio output from primary device with human activity that includes use of the hand held computer device, said system comprising:
(a) a computer system;
(b) the computer readable data storage claimed in claim 1 in communication with the computer system.
